(19) United States
(12) Patent Application Publication
(10) Pub. No.: US 2026/0204778 A1
(43) Pub. Date: Jul. 16, 2026

(54) ANTENNA DEVICE AND COMMUNICATION APPARATUS

(71) Applicant: WNC Corporation, Hsinchu (TW)

(72) Inventors: Wei-Shan CHANG, Hsinchu (TW); Chi-Kang SU, Hsinchu (TW); Chao-Tsu CHEN, Hsinchu (TW)

(21) Appl. No.: 19/358,512

(22) Filed: Oct. 15, 2025

Related U.S. Application Data
(60) Provisional application No. 63/743,696, filed on Jan. 10, 2025.

(30) Foreign Application Priority Data
May 9, 2025 (TW) 114117495

(51) Int. Cl. H01Q 3/24; H01Q 25/00

(52) U.S. Cl. CPC H01Q 3/24; H01Q 25/002

(57) ABSTRACT

An antenna device includes an antenna array, the antenna array includes a plurality of antenna units, and the plurality of antenna units are configured to switch between an active state and an inactive state, such that the antenna array is in a first mode, a second mode, or a third mode. In the first mode, only one of the plurality of antenna units is in the active state; in the second mode, the antenna units in the active state among the plurality of antenna units are arranged as a line; and in the third mode, the antenna units in the active state among the plurality of antenna units are arranged as a polygon.

### RELATED APPLICATIONS

This application claims the benefit of priority to US provisional application No. 63/743,696 filed on January 10, 2025, and Taiwan Patent Application No. 114117495 filed on May 9, 2025. The entire content of the above identified applications are incorporated herein by reference.

### BACKGROUND

### Technical Field

The present disclosure relates to an antenna device and a communication apparatus, particularly to an antenna device and a communication apparatus that can switch between different antenna operating modes.

### Description of Related Art

Different radiation patterns of antennas can be applied in various scenarios. When the radiation pattern is broader, signals can be received or transmitted in a wider range; when the radiation pattern is narrower, the signal strength can be enhanced in a specific direction while avoiding signal interference from other directions. Therefore, if an antenna device can switch between different radiation patterns, it can select the appropriate radiation pattern based on different application scenarios.

In conventional techniques, the same set of antenna (which may be a single antenna or an antenna array) can only generate one type of radiation pattern, and it is necessary to switch between different sets of antennas to achieve different radiation patterns. For example, a communication apparatus may have three sets of antennas, wherein the first set of antenna generates a first radiation pattern, the second set of antenna generates a second radiation pattern, and the third set of antenna generates a third radiation pattern. Such design of multiple sets of antennas requires a larger space. As products become smaller, switching between different radiation patterns in a limited space has become a challenge.

In addition, radiation pattern specifications are also a consideration. In some applications, radiation pattern specifications may include, but are not limited to, the beamwidth and the size of the main lobe relative to the side lobe. Some applications may have certain requirements for radiation pattern specifications, which further increases the difficulty of antenna design.

In view of the above, there is a need for an antenna device that is compact in size, can switch between different radiation patterns and can also satisfy the requirements on radiation pattern specifications.

### SUMMARY

An antenna device is provided according to some embodiments of the present disclosure. The antenna includes an antenna array. The antenna array includes a plurality of antenna units, and the plurality of antenna units are configured to switch between an active state and an inactive state, such that the antenna array is in a first mode, a second mode, or a third mode. Wherein, in the first mode, only one antenna unit among the plurality of antenna units is in the active state; in the second mode, the antenna units in the active state among the plurality of antenna units are arranged as a line; in the third mode, the antenna units in the active state among the plurality of antenna units are arranged as a polygon.

A communication apparatus is provided according to some embodiments of the present disclosure. The communication apparatus includes an antenna array and a processor. The antenna array includes a plurality of antenna units, and the plurality of antenna units are configured to switch between an active state and an inactive state, such that the antenna array is in a first mode, a second mode, or a third mode. The processor is configured to control whether the plurality of antenna units are in the active state or the inactive state, wherein: in the first mode, only one antenna unit among the plurality of antenna units is in the active state; in the second mode, the antenna units in the active state among the plurality of antenna units are arranged as a line; in the third mode, the antenna units in the active state among the plurality of antenna units are arranged as a polygon.

An antenna device is provided according to some embodiments of the present disclosure. The antenna device includes an antenna array. The antenna array includes a plurality of antenna units, and the plurality of antenna units are configured to switch between an active state and an inactive state, such that the antenna array is in a first mode, a second mode, or a third mode. Wherein, the plurality of antenna units are arranged as at least two rows, the antenna units in the same row among the at least two rows are aligned to form a line, and the antenna units in adjacent different rows among the at least two rows are arranged in a staggered manner. In the first mode, only one antenna unit among the plurality of antenna units is in the active state; in the second mode, each row among the at least two rows has one antenna unit in the active state; and in the third mode, each row among the at least two rows has at least two antenna units in the active state.

### BRIEF DESCRIPTION OF THE DRAWINGS

The described embodiments may be better understood by reference to the following description and the accompanying drawings.

FIG. 1 shows a schematic view of the beamwidths of different radiation patterns in the azimuth plane and elevation plane.

FIG. 2A shows a schematic view of an antenna device according to a first embodiment of the present disclosure.

FIG. 2B shows a schematic view of an arrangement of the antenna array according to the first embodiment of the present disclosure and its different operating modes.

FIG. 2C shows a schematic view of another arrangement of the antenna array according to the first embodiment of the present disclosure and its different operating modes.

FIG. 2D shows a schematic view of the configuration of antenna units and switches according to the first embodiment of the present disclosure.

FIG. 2E shows the states of the switches corresponding to different operating modes of the antenna device according to the first embodiment of the present disclosure.

FIG. 3A shows a schematic view of an antenna device according to a second embodiment of the present disclosure.

FIG. 3B shows a schematic view of different operating modes of the antenna array according to the second embodiment of the present disclosure.

FIG. 3C shows a schematic view of the configuration of antenna units and switches according to the second embodiment of the present disclosure.

FIG. 3D shows the states of the switches corresponding to different operating modes of the antenna device according to the second embodiment of the present disclosure.

FIG. 4A shows a schematic view of an antenna device according to a third embodiment of the present disclosure.

FIG. 4B shows a schematic view of an arrangement of the antenna array according to the third embodiment of the present disclosure and its different operating modes.

FIG. 4C shows a schematic view of another arrangement of the antenna array according to the third embodiment of the present disclosure and its different operating modes.

FIG. 4D shows a schematic view of the configuration of antenna units and switches according to the third embodiment of the present disclosure.

FIG. 4E shows the states of the switches corresponding to different operating modes of the antenna device according to the third embodiment of the present disclosure.

FIG. 5A and FIG. 5B show schematic views of a 2×2 antenna array and its radiation patterns in different operating modes according to some embodiments of the present disclosure.

FIG. 6A and FIG. 6B show schematic views of a 3×3 antenna array and its radiation patterns in different operating modes according to some embodiments of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The rows and columns described in the present disclosure are merely for the convenience of expressing the corresponding positions of elements, and rows and columns can be interchanged by rotating 90 degrees. The rows and columns described in the present disclosure should not be interpreted as restrictions on the horizontal and vertical positions.

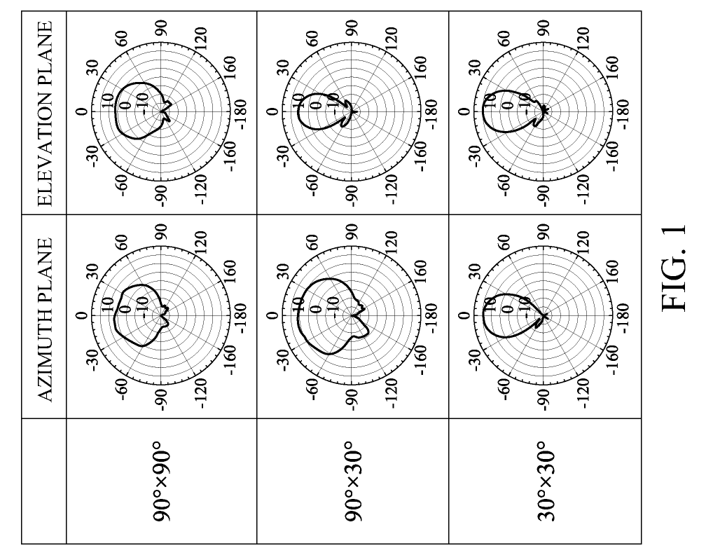

FIG. 1 exemplifies the distribution of three different antenna radiation patterns in the azimuth plane and elevation plane, wherein the 3 dB beamwidth of each radiation pattern is represented in FIG. 1 as "azimuth plane beamwidth × elevation plane beamwidth." A 90°×90° radiation pattern indicates that both the azimuth plane and elevation plane beamwidths are 90°; specifically, the maximum gain in the azimuth plane is about 7 dB at -15°, and the 3 dB beamwidth is about 4 dB at -45° to +45°, thus the beamwidth in the azimuth plane is about 90°. Similarly, the maximum gain in the elevation plane is about 6 dB at 0°, and the 3 dB beamwidth is about 3 dB at -45° to +45°, thus the beamwidth in the elevation plane is also about 90°. Therefore, the "azimuth plane beamwidth × elevation plane beamwidth" of the aforementioned radiation pattern is 90°×90°. Likewise, in a 90°×30° radiation pattern, the azimuth plane beamwidth and elevation plane beamwidth are 90° and 30°, respectively, and in a 30°×30° radiation pattern, both the azimuth plane beamwidth and elevation plane beamwidth are 30°. The radiation patterns shown in FIG. 1 are merely examples, and actual measured results may differ from those shown in FIG. 1, but the beamwidths can be determined in the same manner.

Different radiation patterns can be applied in various scenarios. For instance, in applications involving MIMO (Multiple Input and Multiple Output) or MU-MIMO (Multi-User Multiple-Input and Multiple-Output) technology, communication may occur between access point devices and multiple user devices (such as mobile phones, laptops, etc.). Since multiple user devices may be distributed in different locations, when the access point device needs to receive signals from user devices, it can use a wider pattern (e.g., 90°×90°) to cover a broader receiving range. When an access point device wants to send a signal to a specific user device at a particular location, a narrower pattern (e.g., 90°×30° or 30°×30°) can be used to enhance the signal strength in a specific direction while avoiding signal interference from other directions.

In order to switch between the aforementioned different radiation patterns while also achieving a compact size for the antenna device, the present disclosure provides an antenna array capable of switching between different radiation patterns.

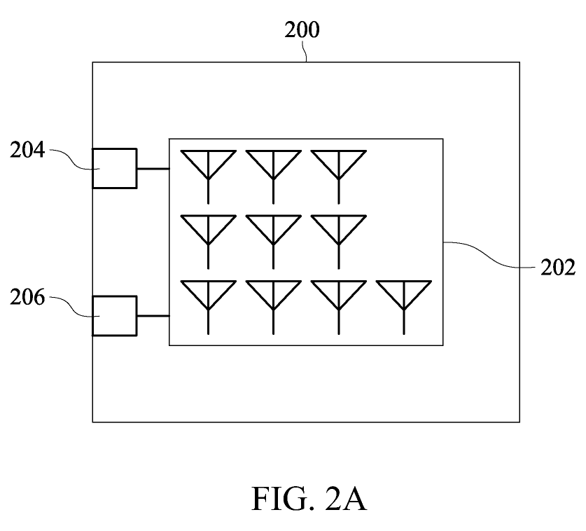

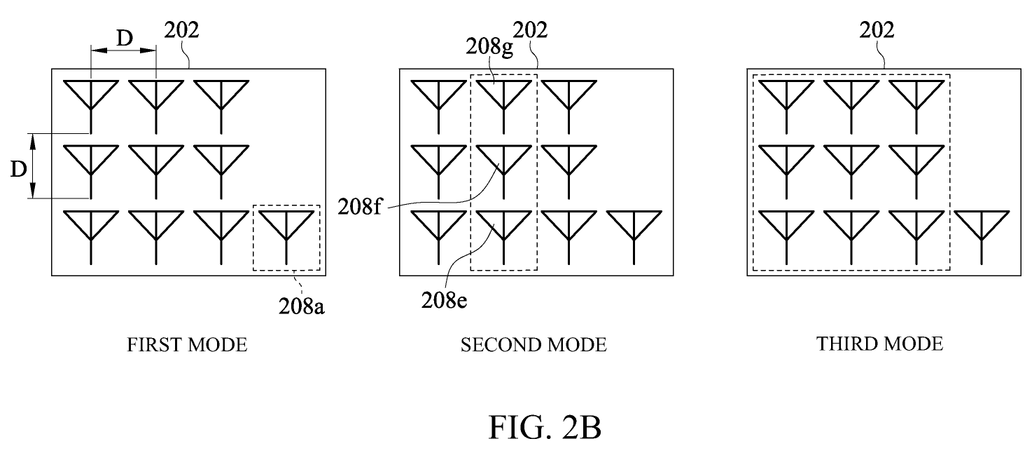

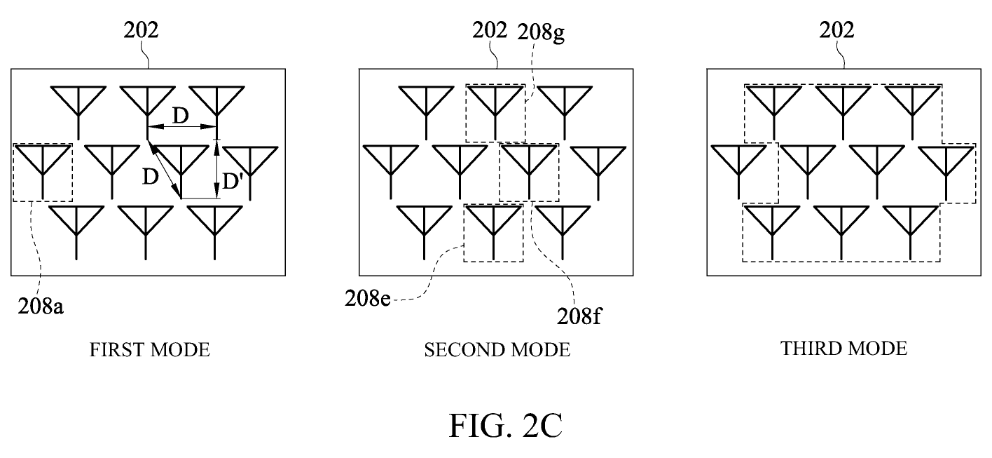

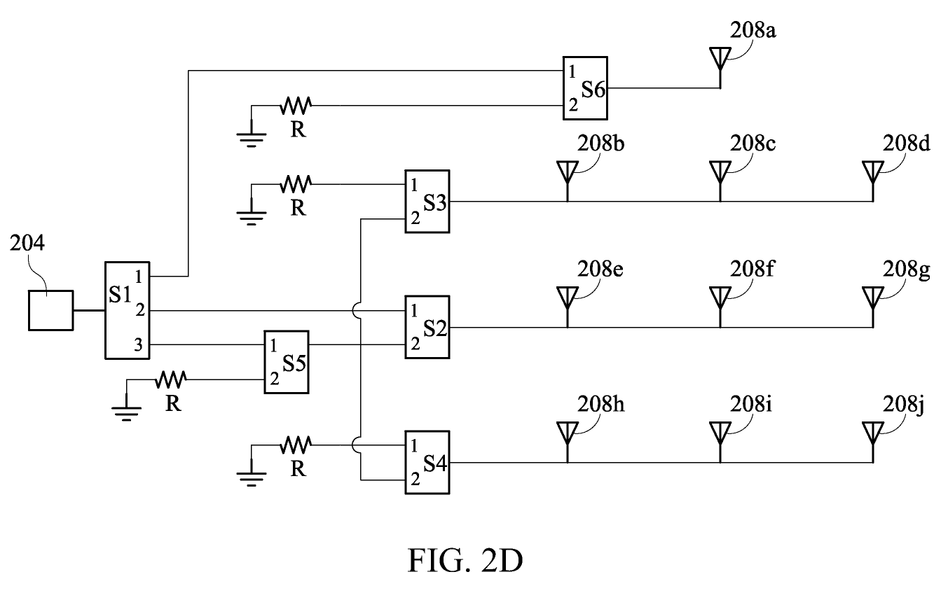

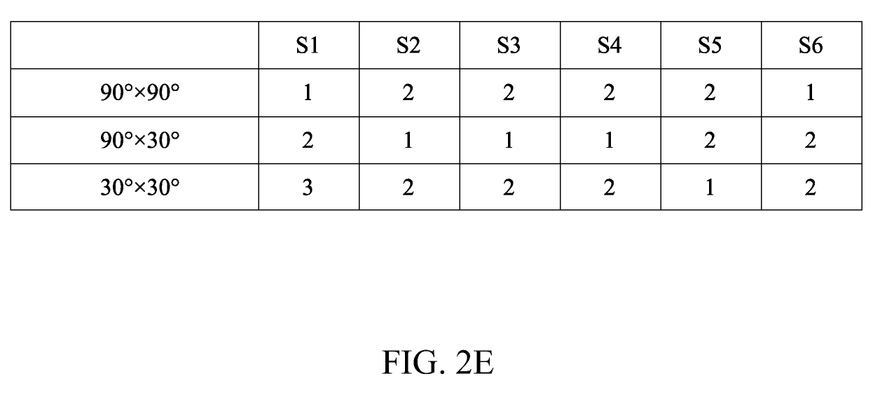

FIG. 2A shows a schematic view of antenna device 200 according to a first embodiment of the present disclosure. FIG. 2B shows a schematic view of an arrangement of the antenna array 202 and its different operating modes according to the first embodiment of the present disclosure. FIG. 2C shows a schematic view of another arrangement of the antenna array 202 and its different operating modes according to the first embodiment of the present disclosure. FIG. 2D shows a schematic view of the configuration of antenna units 208a-208j and switches S1-S6 according to the first embodiment of the present disclosure. FIG. 2E shows the states of switches S1-S6 corresponding to different operating modes of antenna device 200 according to the first embodiment of the present disclosure. Please refer to FIGS. 2A to 2E together.

FIG. 2A shows antenna device 200, which includes antenna array 202 and ports 204, 206. Antenna array 202 and ports 204, 206 can be placed on a substrate (e.g., a circuit board). Antenna array 202 can include a plurality of antenna units 208a-208j (refer to FIG. 2D), and antenna units 208a-208j can be any type of antenna, including but not limited to dipole antennas, monopole antennas, microstrip antennas, planar inverted-F antennas (PIFA), etc. Ports 204 and 206 can be used for the input and output of signals. For example, port 204 can be used to receive and send antenna signals from and to antenna units 208a-208j. Additionally, the communication apparatus may include antenna device 200 and a processor (not shown), wherein the processor can transmit control signals for switches S1-S6 through port 206 to control the active and inactive states of antenna units 208a-208j using switches S1-S6. In some embodiments, ports 204 and 206 may be connected to different processors or control units. In some alternative embodiments, ports 204 and 206 may be removed, allowing the processor and/or control unit to connect directly to antenna array 202. Other variations of the embodiments of the present disclosure may also be made, but are not listed exhaustively herein for conciseness.

Antenna array 202 includes ten antenna units 208a-208j (refer to FIG. 2D), wherein antenna units 208a-208j may have different arrangements, such as those shown in FIGS. 2B and 2C.

In the arrangement shown in FIG. 2B, nine antenna units 208b-208j are arranged as three rows and three columns to form a rectangle, and the tenth antenna unit 208a is arranged to align with one of the three rows or one of the three columns. The spacing D between each pair of adjacent antenna units among the plurality of antenna units 208a-208j in antenna array 202 shown in FIG. 2B can be the same. The spacing D may affect the gain and the side lobes of the antenna radiation, and in some embodiments, the value of spacing D may be selected to be 0.4 to 0.75 times the wavelength of the antenna radiation. The spacing D can be adjusted according to the requirements on antenna specifications to achieve suitable gains and side lobes. In alternative embodiments, antenna units 208a-208j may also be arranged as other shapes.

As shown in FIG. 2B, antenna array 202 can switch between operating modes of the first mode, second mode, and third mode. The active state antenna units are indicated by dashed lines in FIG. 2B. In the first mode, only one antenna unit is in the active state (corresponding to antenna unit 208a in FIG. 2D). In the second mode, the active state antenna units are arranged as a line (corresponding to antenna units 208e, 208f, 208g in FIG. 2D); wherein, the line shown in FIG. 2B is located in the second column, but in alternative embodiments, the line may also be located in other rows, other columns, or may be a diagonal line involving different rows and columns simultaneously. In the third mode, the active state antenna units are arranged as a polygon (corresponding to antenna units 208b-208j in FIG. 2D), wherein the polygon can be rectangular or other shapes.

FIG. 2C shows another arrangement of antenna units 208a-208j in antenna array 202. Compared to FIG. 2B, the position of antenna unit 208a in FIG. 2C has changed, and antenna units 208a-208j are arranged in a staggered manner. Specifically, the antenna units 208b-208j in FIG. 2C are arranged into at least two rows (FIG. 2C shows three rows), wherein the antenna units in the same row among the at least two rows are aligned to form a line, and the antenna units in different adjacent rows are arranged in a staggered manner. In the first mode, only one antenna unit is in the active state (corresponding to antenna unit 208a in FIG. 2D). In the second mode, each staggered row has one antenna unit in the active state (corresponding to antenna units 208e, 208f, 208g in FIG. 2D). In the third mode, each row among the at least two rows has at least two active state antenna units (FIG. 2C shows three active state antenna units in each row, corresponding to antenna units 208b-208j in FIG. 2D), and the active state antenna units are arranged as a polygon. In the arrangement shown in FIG. 2C, the spacing D between each pair of adjacent antenna units in the same row may be the same, and the spacing D between each pair of adjacent antenna units in different rows (e.g., antenna unit 208e and antenna unit 208f, or antenna unit 208f and antenna unit 208g, etc.) may also be the same. Compared to the arrangement in FIG. 2B, the arrangement in FIG. 2C may reduce the spacing D’ between rows, such that D’ < D. Accordingly, the arrangement in FIG. 2C may further reduce the size of antenna array 202.

Antenna array 202 in the first mode is configured to generate a first radiation pattern, the antenna array 202 in the second mode is configured to generate a second radiation pattern, and the antenna array 202 in the third mode is configured to generate a third radiation pattern, wherein the first radiation pattern, second radiation pattern, and third radiation pattern are different from each other. For example, the first radiation pattern may be a 90°×90° pattern, the second radiation pattern may be a 90°×30° pattern, and the third radiation pattern may be a 30°×30° pattern. Therefore, the beamwidth of the first radiation pattern in the first plane (e.g., azimuth plane) is wider than the beamwidth of the third radiation pattern in the first plane; the beamwidth of the first radiation pattern in the second plane (e.g., elevation plane) is wider than the beamwidth of the second radiation pattern in the second plane and the beamwidth of the third radiation pattern in the second plane; the beamwidth of the second radiation pattern in the first plane is wider than the beamwidth of the third radiation pattern in the first plane; and the beamwidth of the second radiation pattern in the first plane is wider than the beamwidth of the second radiation pattern in the second plane, wherein the first plane is different from the second plane.

Since the first radiation pattern, second radiation pattern, and third radiation pattern are all generated by the same antenna array 202, the space occupied by antenna device 200 can be reduced. Furthermore, regarding the beamwidth specifications of radiation patterns, the 90°×90° pattern is broader and can cover a wider signal transmission and reception range. The 30°×30° pattern is narrower and can enhance the signal strength in a specific direction while avoiding signal interference from other directions. The 90°×30° pattern is broader in the azimuth plane and narrower in the elevation plane. The antenna device 200 can select the appropriate radiation pattern as needed.

Referring to FIGS. 2D and 2E, antenna device 200 can control, through the switching of switches S1-S6, which of the antenna units 208a-208j are connected to port 204 to receive and send antenna signals. Switch S1 has terminal 1, terminal 2, and terminal 3, while switches S2-S6 have terminal 1 and terminal 2. The active state antenna units are connected to port 204 through one or more of switches S1-S6 to receive and send antenna signals. The inactive state antenna units are connected to one of a plurality of resistors R through one or more of switches S1-S6 and then grounded through the resistor R to prevent the inactive state antenna units from affecting the active state antenna units. The resistance value of each of the plurality of resistors R can be selected to be the characteristic impedance Z₀ of antenna device 200. When the resistance value of resistor R is close to the characteristic impedance Z₀ of antenna device 200, signal reflections at resistor R can be reduced, thus minimizing the impact of the inactive state antenna units on the active state antenna units. In some embodiments, corresponding to the characteristic impedance Z₀, the resistance value of resistor R may be approximately equal to 50 ohms to reduce signal reflections at resistor R. In some alternative embodiments, the resistance value of resistor R may also be approximately equal to 75 ohms or other values close to the characteristic impedance Z₀.

In the 90°×90° first radiation pattern of the first embodiment (corresponding to the first mode of antenna array 202), switches S1 and S6 switch to terminal 1, and switches S2-S5 switch to terminal 2, such that port 204 is connected to antenna unit 208a to receive and send antenna signals, and antenna units 208b-208j are connected to one of the plurality of resistors R; therefore, antenna unit 208a is in the active state, and antenna units 208b-208j are in the inactive state.

In the 90°×30° second radiation pattern of the first embodiment (corresponding to the second mode of antenna array 202), switches S1, S5, and S6 switch to terminal 2, and switches S2-S4 switch to terminal 1, such that port 204 is connected to antenna units 208e, 208f, and 208g arranged as a line to receive and send antenna signals, while antenna units 208a-208d and 208h-208j are connected to one of the plurality of resistors R; therefore, antenna units 208e, 208f, and 208g are in the active state, and antenna units 208a-208d and 208h-208j are in the inactive state.

In the 30°×30° third radiation pattern of the first embodiment (corresponding to the third mode of antenna array 202), switch S1 switches to terminal 3, switch S5 switches to terminal 1, and switches S2, S3, S4, and S6 switch to terminal 2, such that port 204 is connected to antenna units 208b-208j arranged as a rectangle to receive and send antenna signals, and antenna unit 208a is connected to one of the plurality of resistors R; therefore, antenna units 208b-208j are in the active state, and antenna unit 208a is in the inactive state.

In the first mode, second mode, and third mode of antenna array 202, there are respectively one, three, and nine antenna unit(s) in the active state, wherein the active state antenna unit(s) in the first mode, second mode, and third mode of antenna array 202 can be regarded as being respectively arranged into a "point, line, and surface." When multiple antenna units are in the active state (e.g., in the second mode and third mode of antenna array 202), the radiation between different antenna units will affect each other, thereby changing the overall radiation pattern of antenna array 202; this technique is known as "beamforming" in related fields. The same principle can also be applied to other embodiments of the present disclosure.

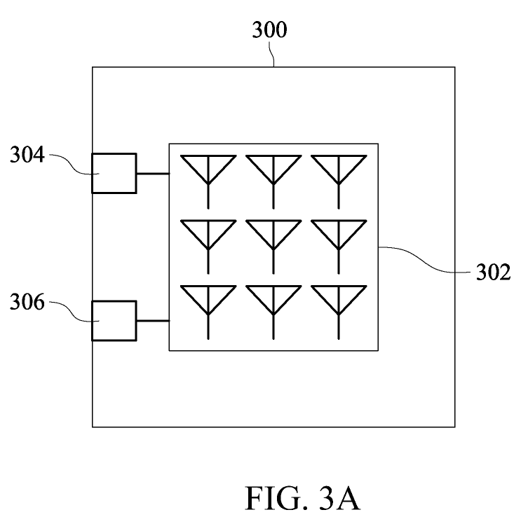

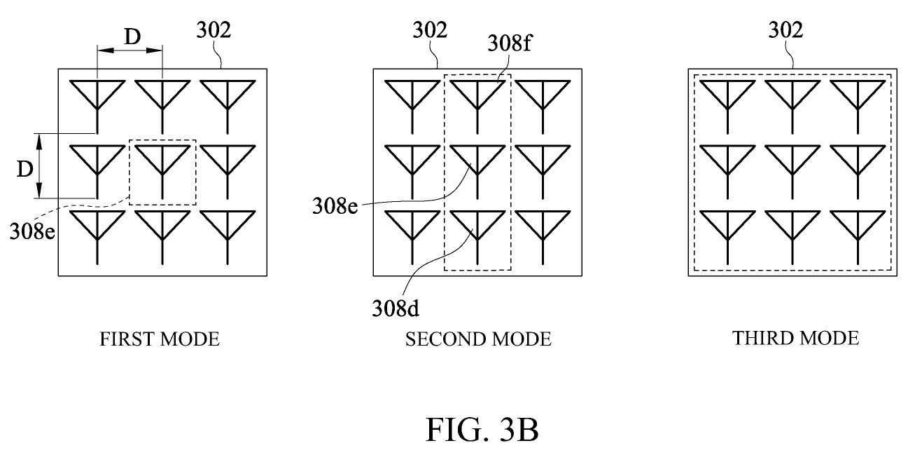

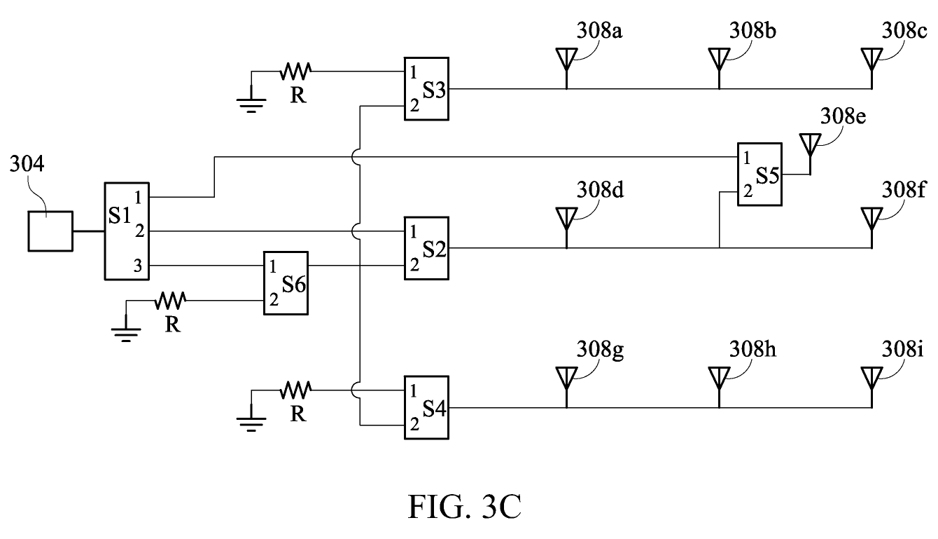

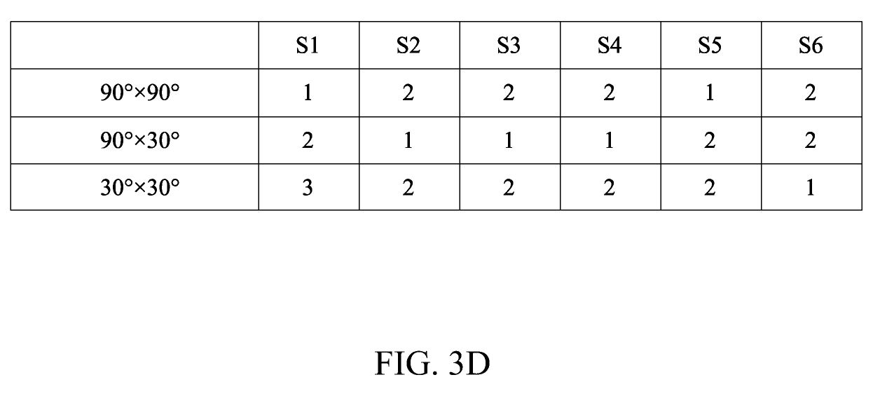

FIG. 3A shows a schematic view of antenna device 300 according to a second embodiment of the present disclosure. FIG. 3B shows a schematic view of different operating modes of antenna array 302 according to the second embodiment of the present disclosure. FIG. 3C shows a schematic view of the configuration of antenna units 308a-308i and switches S1-S6 according to the second embodiment of the present disclosure. FIG. 3D shows the states of switches S1-S6 corresponding to different operating modes of antenna device 300 according to the second embodiment of the present disclosure. Please refer to FIGS. 3A to 3D together.

FIG. 3A shows antenna device 300, which includes antenna array 302 and ports 304, 306. Port 304 can be used to receive and send antenna signals from and to antenna units 308a-308i, and port 306 can be used to transmit control signals for switches S1-S6. Ports 304 and 306 are similar to ports 204 and 206, so further details and variations of ports 304 and 306 are not repeated herein.

Antenna array 302 includes nine antenna units 308a-308i (refer to FIG. 3C), wherein the nine antenna units 308a-308i are arranged as three rows and three columns to form a rectangle. In alternative embodiments, antenna units 308a-308i may also be arranged into other shapes.

As shown in FIG. 3B, antenna array 302 can switch between the first mode, second mode, and third mode, and the active state antenna units in each operating mode are indicated by dashed lines. In the first mode, only one antenna unit is in the active state (corresponding to antenna unit 308e in FIG. 3C). In the second mode, the active state antenna units are arranged as a line (corresponding to antenna units 308d, 308e, 308f in FIG. 3C); wherein, the line shown in FIG. 3B is located in the second row, but in alternative embodiments, the line may also be located in other rows, other columns, or may be a diagonal line involving different rows and columns simultaneously. In the third mode, the active state antenna units are arranged as a polygon (corresponding to antenna units 308a-308i in FIG. 3C), wherein the polygon can be rectangular or other shapes.

From the comparison between FIG. 3B and FIG. 2B, it can be seen that antenna array 302 has one less antenna unit than antenna array 202, thus the size of antenna array 302 may be smaller than that of antenna array 202, which can further reduce the space occupied by antenna device 300. Additionally, the one antenna unit in the active state in the first mode of antenna array 302 (corresponding to antenna unit 308e in FIG. 3C) is located at the center of antenna array 302, while the one antenna unit in the active state in the first mode of antenna array 202 (corresponding to antenna unit 208a in FIG. 2D) is located at the periphery of antenna array 202. Generally, arranging the one antenna unit in the active state in the first mode at the periphery of the antenna array can help prevent it from being affected by other inactive state antenna units, so the performance of the radiation pattern of antenna array 202 in the first mode may be better than that of antenna array 302 in the first mode. However, in actual situations, there may be other components or metal casings near antenna devices 200 and 300, which may also affect the radiation patterns of antenna devices 200 and 300; therefore, testing can be conducted in actual situations for different antenna arrays 202, 302 to determine the appropriate configuration.

Referring to FIGS. 3C and 3D, antenna device 300 can control, through the switching of switches S1-S6, which of the antenna units 308a-308i are connected to port 304 to receive and send antenna signals. Switch S1 has terminal 1, terminal 2, and terminal 3, while switches S2-S6 have terminal 1 and terminal 2. The active state antenna units are connected to port 304 through one or more of switches S1-S6 to receive and send antenna signals. The inactive state antenna units are connected to one of a plurality of resistors R through one or more of switches S1-S6 and then grounded through the resistor R to prevent the inactive state antenna units from affecting the active state antenna units. Similar to those previously described, the resistance value of each of the plurality of resistors R can be selected to be 50 ohms or other values close to the characteristic impedance Z₀ of antenna device 300 to reduce signal reflections at resistor R. When the signal reflections at the inactive state antenna units are small, the impact of the inactive state antenna units on the active state antenna units can be further reduced.

In 90°×90° first radiation pattern of the second embodiment (corresponding to the first mode of antenna array 302), switches S1 and S5 switch to terminal 1, and switches S2, S3, S4, and S6 switch to terminal 2, such that port 304 is connected to antenna unit 308e to receive and send antenna signals, while antenna units 308a-308d and 308f-308i are connected to one of the plurality of resistors R; therefore, antenna unit 308e is in the active state, and antenna units 308a-308d and 308f-308i are in the inactive state.

In the 90°×30° second radiation pattern of the second embodiment (corresponding to the second mode of antenna array 302), switches S1, S5, and S6 switch to terminal 2, and switches S2-S4 switch to terminal 1, such that port 304 is connected to antenna units 308d, 308e, and 308f arranged as a line to receive and send antenna signals, while antenna units 308a-308c and 308g-308i are connected to one of the plurality of resistors R; therefore, antenna units 308d, 308e, and 308f are in the active state, and antenna units 308a-308c and 308g-308i are in the inactive state.

In the 30°×30° third radiation pattern of second embodiment (corresponding to the third mode of antenna array 302), switch S1 switches to terminal 3, switch S6 switches to terminal 1, and switches S2, S3, S4, and S5 switch to terminal 2, such that port 304 is connected to antenna units 308a-308i arranged as a rectangle to receive and send antenna signals; therefore, all antenna units 308a-308i are in the active state, and there are no antenna units in the inactive state.

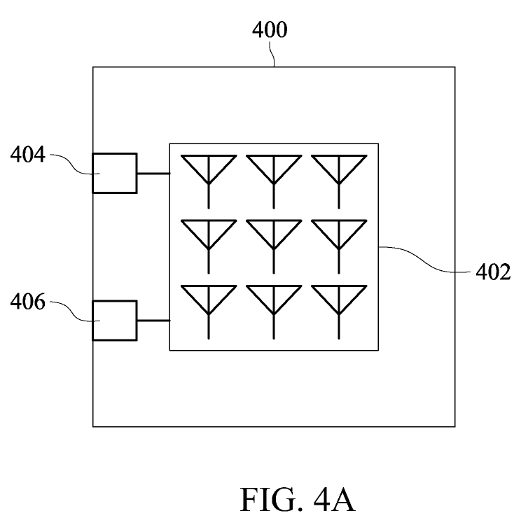

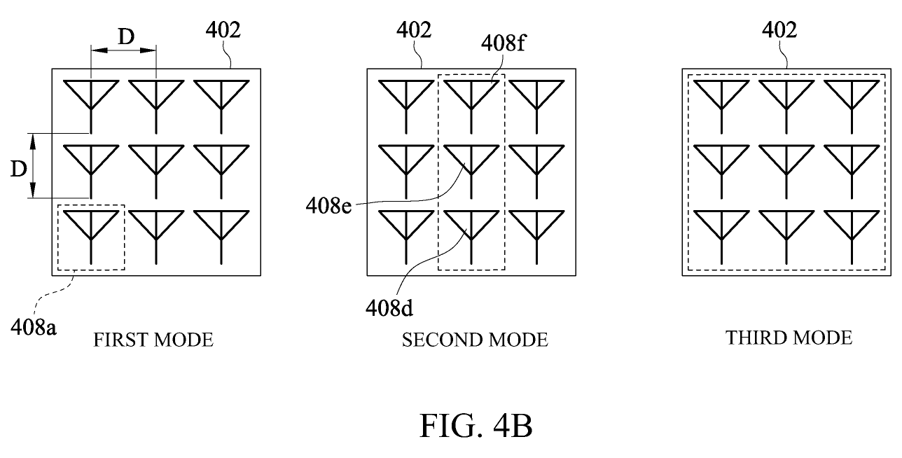

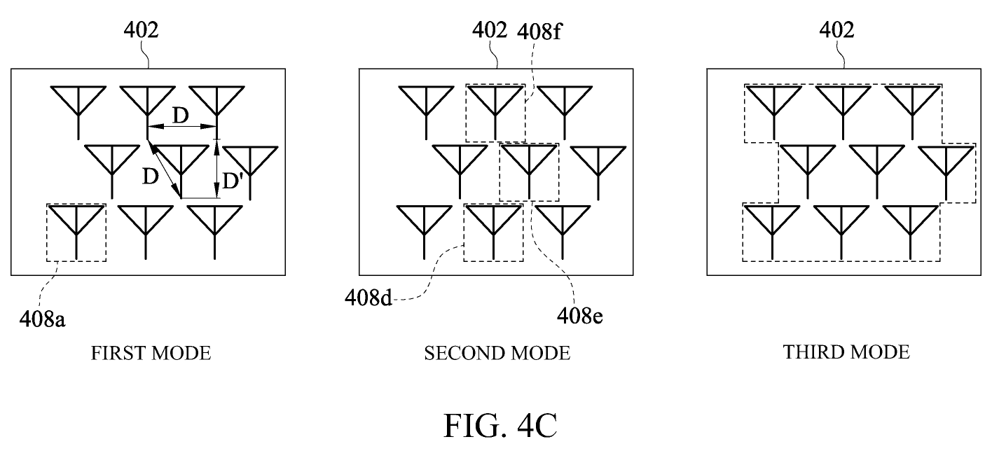

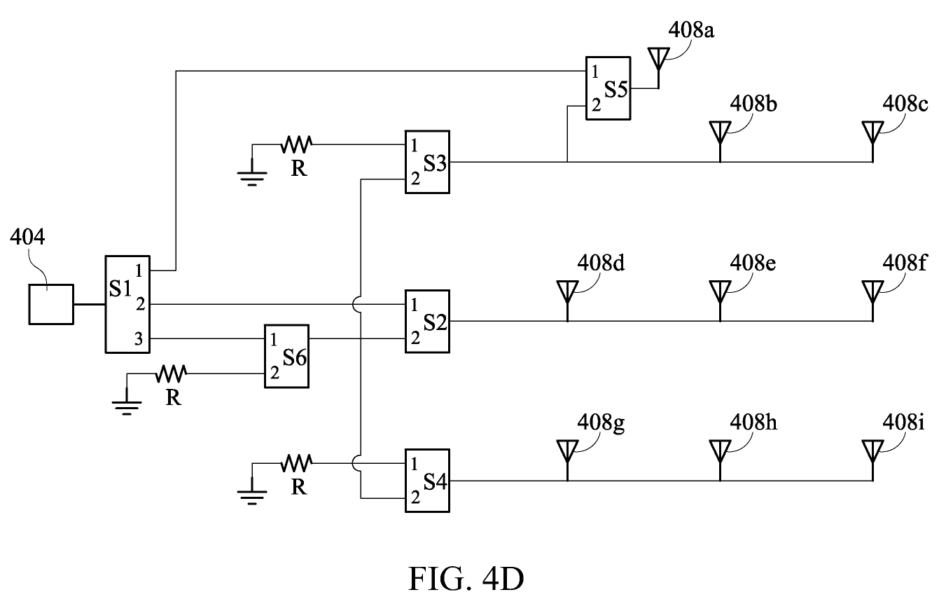

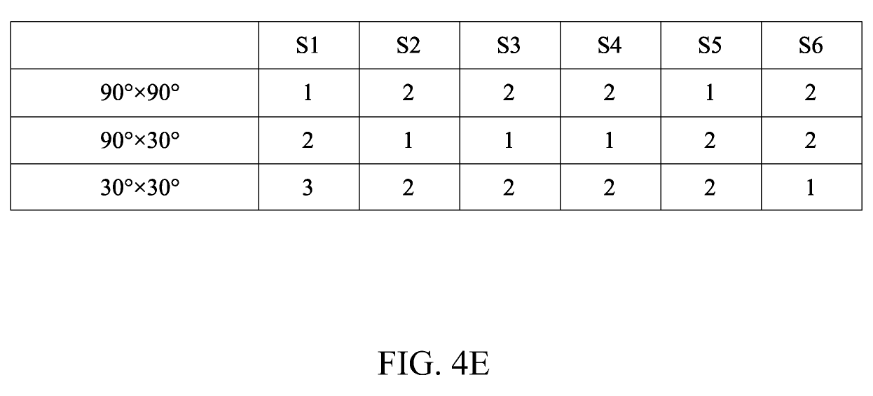

FIG. 4A shows a schematic view of antenna device 400 according to a third embodiment of the present disclosure. FIG. 4B shows a schematic view of an arrangement of antenna array 402 and its different operating modes according to the third embodiment of the present disclosure. FIG. 4C shows a schematic view of another arrangement of antenna array 402 and its different operating modes according to the third embodiment of the present disclosure. FIG. 4D shows a schematic view of the configuration of antenna units 408a-408i and switches S1-S6 according to the third embodiment of the present disclosure. FIG. 4E shows the states of switches S1-S6 corresponding to different operating modes of antenna device 400 according to the third embodiment of the present disclosure. Please refer to FIGS. 4A to 4E together.

FIG. 4A shows antenna device 400, which includes antenna array 402 and ports 404, 406. Port 404 can be used to receive and send antenna signals from and to antenna units 408a-408i, and port 406 can be used to transmit control signals for switches S1-S6. Ports 404 and 406 are similar to ports 204 and 206, so further details and variations of ports 404 and 406 are not repeated herein.

Antenna array 402 includes nine antenna units 408a-408i (refer to FIG. 4D), wherein antenna units 408a-408i may have different arrangements, such as those shown in FIGS. 4B and 4C.

In the arrangement shown in FIG. 4B, nine antenna units 408a-408i are arranged as three rows and three columns to form a rectangle. The spacing D between each pair of adjacent antenna units among the plurality of antenna units 408a-408i in antenna array 402 shown in FIG. 4B may be the same. The spacing D may affect the gain and the side lobes of the antenna radiation, and in some embodiments, the value of spacing D may be selected to be 0.4 to 0.75 times the wavelength of the antenna radiation. The spacing D can be adjusted according to the requirements on antenna specifications to achieve suitable gains and side lobes. In alternative embodiments, antenna units 408a-408i may also be arranged as other shapes.

As shown in FIG. 4B, antenna array 402 can switch between the first mode, second mode, and third mode. The active state antenna units in each operating mode are indicated by dashed lines. In the first mode, only one antenna unit is in the active state (corresponding to antenna unit 408a in FIG. 4D). In the second mode, the active state antenna units are arranged as a line (corresponding to antenna units 408d, 408e, 408f in FIG. 4D); wherein, the line shown in FIG. 4B is located in the second column, but in alternative embodiments, the line may also be located in other rows, other columns, or may be a diagonal line involving different rows and columns simultaneously. In the third mode, the active state antenna units are arranged as a polygon (corresponding to antenna units 408a-408i in FIG. 4D), wherein the polygon can be rectangular or other shapes.

FIG. 4C shows another arrangement of antenna units 408a-408i in antenna array 402. Compared to FIG. 4B, the antenna units 408a-408i in FIG. 4C are arranged in a staggered manner. Specifically, the antenna units 408a-408iin FIG. 4C are arranged into at least two rows (FIG. 4C shows three rows), wherein the antenna units in the same row among the at least two rows are aligned to form a line, and the antenna units in different adjacent rows are arranged in a staggered manner. In the first mode, only one antenna unit is in the active state (corresponding to antenna unit 408a in FIG. 4D). In the second mode, each staggered row has one antenna unit in the active state (corresponding to antenna units 408d, 408e, 408f in FIG. 4D). In the third mode, each row among the at least two rows has at least two active state antenna units (FIG. 4C shows three active state antenna units in each row, corresponding to antenna units 408a-408i in FIG. 4D), and the active state antenna units are arranged as a polygon. In the arrangement shown in FIG. 4C, the spacing D between each pair of adjacent antenna units in the same row may be the same, and the spacing D between each pair of adjacent antenna units in different rows (e.g., antenna unit 408d and antenna unit 408e, or antenna unit 408e and antenna unit 408f, etc.) may also be the same. Compared to the arrangement in FIG. 4B, the arrangement in FIG. 4C may reduce the spacing D’ between rows, such that D’ < D. Thus, the arrangement in FIG. 4C may further reduce the size of antenna array 402.

From the comparison between FIGS. 4B, 3B, and 2B, it can be seen that antenna array 402 has one less antenna unit than antenna array 202, thus the size of antenna array 402 may be smaller than that of antenna array 202, which can further reduce the space occupied by antenna device 400. Additionally, the one antenna unit in the active state in the first mode of antenna array 402 (corresponding to antenna unit 408a in FIG. 4D) is located at the periphery of antenna array 402, while the one antenna unit in the active state in the first mode of antenna array 302 (corresponding to antenna unit 308e in FIG. 3C) is located at the center of antenna array 302. As previously mentioned, arranging the one antenna unit in the active state in the first mode at the periphery of the antenna array may help prevent the one active state antenna unit from being affected by other inactive state antenna units, but testing can still be conducted in actual situations for different antenna arrays 202, 302, and 402 to determine the appropriate configuration.

Referring to FIGS. 4D and 4E, antenna device 400 can control, through the switching of switches S1-S6, which of the antenna units 408a-408i is connected to port 404 to receive and send antenna signals. Switch S1 has terminal 1, terminal 2, and terminal 3, while switches S2-S6 have terminal 1 and terminal 2. The active state antenna units are connected to port 404 through one or more of switches S1-S6 to receive and send antenna signals. The inactive state antenna units are connected to one of a plurality of resistors R through one or more of switches S1-S6 and then grounded through the resistor R to prevent the inactive state antenna units from affecting the active state antenna units. Similar to those previously described, the resistance value of each of the plurality of resistors R can be selected to be 50 ohms or other values close to the characteristic impedance Z₀ of antenna device 400 to reduce signal reflections at resistor R. When the signal reflections at the inactive state antenna units are small, the impact of the inactive state antenna units on the active state antenna units can be further reduced.

In the 90°×90° first radiation pattern of the third embodiment (corresponding to the first mode of antenna array 402), switches S1 and S5 switch to terminal 1, and switches S2, S3, S4, and S6 switch to terminal 2, such that port 404 is connected to antenna unit 408a to receive and send antenna signals, and antenna units 408b-408i are connected to one of the plurality of resistors R; therefore, antenna unit 408a is in the active state, and antenna units 408b-408i are in the inactive state.

In the 90°×30° second radiation pattern of the third embodiment (corresponding to the second mode of antenna array 402), switches S1, S5, and S6 switch to terminal 2, and switches S2-S4 switch to terminal 1, such that port 404 is connected to the line of antenna units 408d, 408e, and 408f to receive and send antenna signals, while antenna units 408a-408c and 408g-408i are connected to one of the plurality of resistors R; therefore, antenna units 408d, 408e, and 408f are in the active state, and antenna units 408a-408c and 408g-408i are in the inactive state.

In the 30°×30° third radiation pattern of the third embodiment (corresponding to the third mode of antenna array 402), switch S1 switches to terminal 3, switch S6 switches to terminal 1, and switches S2, S3, S4, and S5 switch to terminal 2, such that port 404 is connected to the antenna units 408a-408i arranged as a rectangle to receive and send antenna signals; therefore, all antenna units 408a-408iare in the active state, and there are no antenna units in the inactive state.

The plurality of antenna units 208a-208j in antenna array 202 can be configured to be in-phase. In other words, the signals transmitted by the antenna units in the same antenna array can have the same phase. The phase of the signal may be affected by the length of the transmission path, leading to a phase lead or phase lag. For example, assume there is a measured phase difference between antenna units 208a and 208b, then the length of the transmission path corresponding to the phase difference can be calculated, and the distance from antenna unit 208a to switch S6 or the distance from antenna unit 208b to switch S3 can be adjusted accordingly (e.g., increasing or decreasing the straight line distance, or modifying the wire into a serpentine shape to increase the distance) to compensate for the phase difference between antenna units 208a and 208b, making them in-phase. The same phase adjustment method can be applied to each of the antenna units 208a-208j, making the overall phase of antenna units 208a-208j consistent. Similarly, the plurality of antenna units 308a-308i in antenna array 302 can be configured to be in-phase, and the plurality of antenna units 408a-408i in antenna array 402 can also be configured to be in-phase.

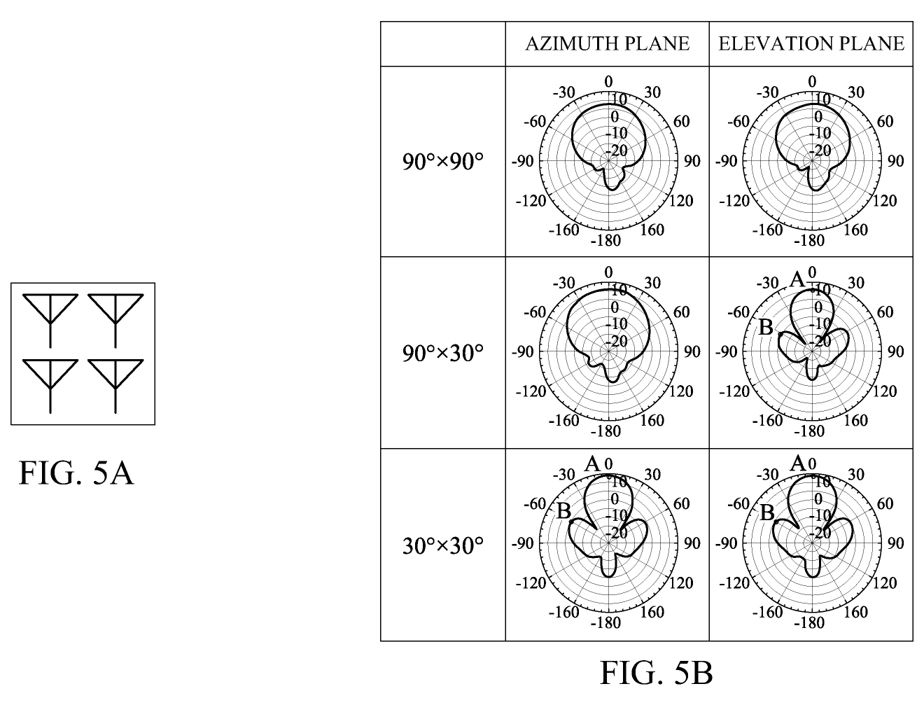

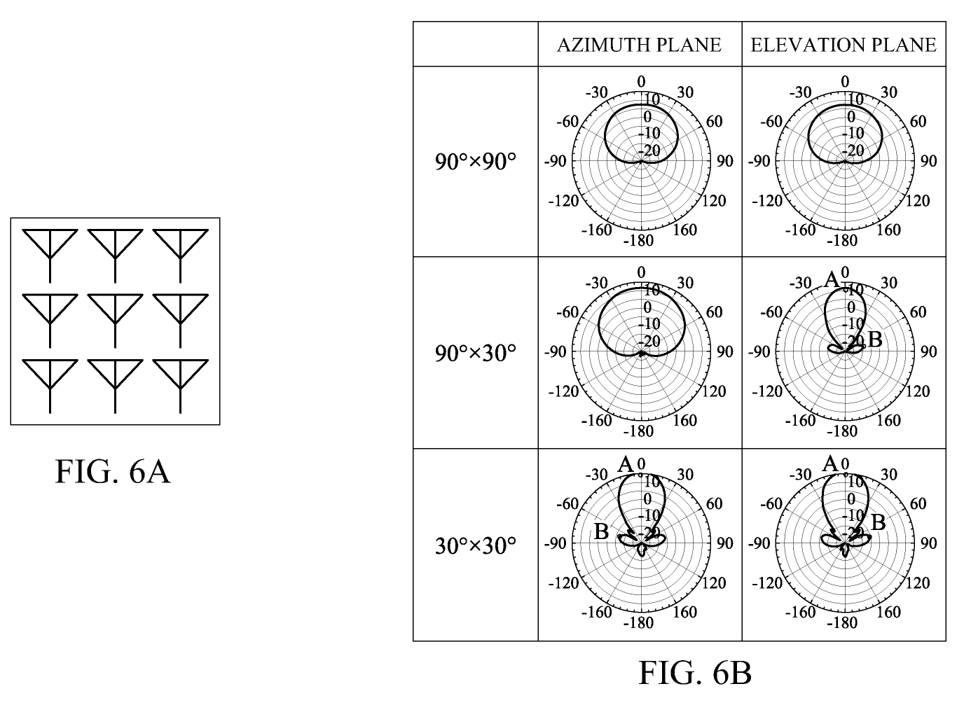

FIG. 5A and FIG. 5B show schematic views of a 2×2 antenna array (i.e., two rows and two columns, totaling four antenna units) and its radiation patterns in different operating modes according to some embodiments of the present disclosure. FIG. 6A and FIG. 6B show schematic views of a 3×3 antenna array (i.e., three rows and three columns, totaling nine antenna units) and its radiation patterns in different operating modes according to some embodiments of the present disclosure. The comparison between FIGS. 5A, 5B and 6A, 6B show how the number of antenna units affect the radiation pattern.

Antenna arrays formed by different numbers of antenna units may create different radiation patterns. In actual situations, the appropriate antenna device can be selected based on factors such as the specifications of the radiation pattern and the size of the antenna device. The specifications of the radiation pattern may include the beamwidth and the size of the main lobe relative to the side lobes. The specifications for beamwidth have been described previously, so FIGS. 5A, 5B, 6A, and 6B describe how the number of antenna units affect the size of the main lobe relative to the side lobes.

As shown in FIG. 5B and FIG. 6B, the radiation pattern in a plane with a beamwidth of 90° does not form a distinct main lobe and side lobes, while the radiation pattern in a plane with a beamwidth of 30° shows the main lobe and side lobes, where the main lobe has a maximum gain A and the side lobe has a maximum gain B. Generally, in directional radiation patterns, it is desirable for the gain at the main lobe to be large and the gain at the side lobe to be small, so as to enhance the signal strength in the direction of the main lobe and reduce signal interference from other directions. The present disclosure calculates the gain difference by subtracting maximum gain B from maximum gain A to evaluate the size of the main lobe relative to the side lobe.

Referring to FIG. 5B, the 2×2 antenna array in both the second mode (90°×30°) and third mode (30°×30°) generates a radiation pattern with approximately 14 dB gain difference in the plane with a 30° beamwidth (i.e., the maximum gain A minus maximum gain B is approximately equal to 14 dB).

Further referring to FIG. 6B, the 3×3 antenna array in both the second mode (90°×30°) and third mode (30°×30°) generates a radiation pattern with approximately 26 dB gain difference in the plane with a 30° beamwidth.

From the above comparison, it can be seen that when the 3×3 antenna array generates a radiation pattern with a beamwidth of 30°, the gain difference between the main lobe and the side lobe is greater than that of the 2×2 antenna array, thus the 3×3 antenna array has a stronger directivity, which can enhance the signal strength in the direction of the main lobe and reduce signal interference from other directions. However, the 3×3 antenna array may also occupy more space than the 2×2 antenna array. Therefore, in actual situations, the appropriate antenna device can be selected based on the specifications required for the radiation pattern and the size constraints. The 3×3 antenna array can be chosen if a better directivity radiation pattern is preferred; the 2×2 antenna array can be chosen if a smaller product size is preferred.

The embodiments were chosen and described in order to explain the principles of the present disclosure and their practical applications. Alternative embodiments will become apparent to those skilled in the art without departing from the spirit and scope of the present disclosure.

What is claimed is:

1. An antenna device, comprising:
an antenna array comprising a plurality of antenna units, the plurality of antenna units being configured to switch between an active state and an inactive state, such that the antenna array is in a first mode, a second mode, or a third mode, wherein:
in the first mode, only one antenna unit among the plurality of antenna units is in the active state;
in the second mode, the antenna units in the active state among the plurality of antenna units are arranged as a line;
in the third mode, the antenna units in the active state among the plurality of antenna units are arranged as a polygon.

2. The antenna device according to claim 1, wherein in the first mode, the one antenna unit in the active state is located at a periphery or a center of the antenna array.

3. The antenna device according to claim 1, wherein the polygon is a rectangle.

4. The antenna device according to claim 1, wherein each of the plurality of antenna units is in-phase.

5. The antenna device according to claim 1, wherein the antenna array in the first mode is configured to generate a first radiation pattern, the antenna array in the second mode is configured to generate a second radiation pattern, the antenna array in the third mode is configured to generate a third radiation pattern, and the first radiation pattern, the second radiation pattern, and the third radiation pattern are different from each other.

6. The antenna device according to claim 5, wherein a beamwidth of the first radiation pattern in a first plane is wider than a beamwidth of the third radiation pattern in the first plane, a beamwidth of the first radiation pattern in a second plane is wider than a beamwidth of the second radiation pattern in the second plane, and the first plane is different from the second plane.

7. The antenna device according to claim 6, wherein the first plane is an azimuth plane and the second plane is an elevation plane.

8. The antenna device according to claim 1, wherein the plurality of antenna units comprises nine antenna units, and the nine antenna units are arranged as three rows and three columns.

9. The antenna device according to claim 8, wherein the plurality of antenna units further comprises a tenth antenna unit, and the tenth antenna unit is arranged to align with one row among the three rows or one column among the three columns.

10. The antenna device according to claim 1, further comprising a plurality of switches and a plurality of resistors, wherein the antenna units in the inactive state among the plurality of antenna units are connected to one of the plurality of resistors via one or more of the plurality of switches.

11. The antenna device according to claim 10, wherein a resistance value of each of the plurality of resistors is 50 ohms or 75 ohms.

12. The antenna device according to claim 10, wherein a resistance value of each of the plurality of resistors is equal to a characteristic impedance of the antenna device.

13. The antenna device according to claim 1, wherein a spacing between each pair of adjacent antenna units among the plurality of antenna units is the same.

14. A communication apparatus, comprising:
an antenna array comprising a plurality of antenna units, the plurality of antenna units being configured to switch between an active state and an inactive state, such that the antenna array is in a first mode, a second mode, or a third mode; and
a processor configured to control whether the plurality of antenna units are in the active state or the inactive state, wherein:
in the first mode, only one antenna unit among the plurality of antenna units is in the active state;
in the second mode, the antenna units in the active state among the plurality of antenna units are arranged as a line;
in the third mode, the antenna units in the active state among the plurality of antenna units are arranged as a polygon.

15. The communication apparatus according to claim 14, wherein the antenna array in the first mode is configured to generate a first radiation pattern, the antenna array in the second mode is configured to generate a second radiation pattern, the antenna array in the third mode is configured to generate a third radiation pattern, and the first radiation pattern, the second radiation pattern, and the third radiation pattern are different from each other.

16. The communication apparatus according to claim 15, wherein a beamwidth of the first radiation pattern in a first plane that is wider than a beamwidth of the third radiation pattern in the first plane, a beamwidth of the first radiation pattern in a second plane is wider than a beamwidth of the second radiation pattern in the second plane, and the first plane is different from the second plane.

17. The communication apparatus according to claim 14, further comprising a plurality of switches and a plurality of resistors, wherein the antenna units in the inactive state among the plurality of antenna units are connected to one of the plurality of resistors via one or more of the plurality of switches.

18. An antenna device, comprising:
an antenna array comprising a plurality of antenna units, the plurality of antenna units being configured to switch between an active state and an inactive state, such that the antenna array is in a first mode, a second mode, or a third mode, wherein:
the plurality of antenna units are arranged as at least two rows, the antenna units in the same row among the at least two rows are aligned to form a line, and the antenna units in adjacent different rows among the at least two rows are arranged in a staggered manner;
in the first mode, only one antenna unit among the plurality of antenna units is in the active state;
in the second mode, each row among the at least two rows has one antenna unit in the active state;
in the third mode, each row among the at least two rows has at least two antenna units in the active state.

19. The antenna device according to claim 18, wherein a spacing between each pair of adjacent antenna units among the plurality of antenna units is the same.

20. The antenna device according to claim 18, wherein the antenna array in the first mode is configured to generate a first radiation pattern, the antenna array in the second mode is configured to generate a second radiation pattern, the antenna array in the third mode is configured to generate a third radiation pattern, and the first radiation pattern, the second radiation pattern, and the third radiation pattern are different from each other.
